(19) United States
(12) Patent Application Publication
(10) Pub. No.: US 2011/0204709 A1
(43) Pub. Date: Aug. 25, 2011

(54) Method for improving the braking performance of a vehicle

(76) Inventors: Rainer BRUEGGEMANN, Ludwigsburg (DE); Philipp Frueh, Clayton (AU)

(21) Appl. No.: 13/024,937

(22) Filed: Feb. 10, 2011

(30) Foreign Application Priority Data
Feb. 23, 2010 (DE) 102010002240.3

(51) Int. Cl. B60T 8/34; B60T 8/26; B60T 8/176

(52) U.S. Cl. 303/113.1

(57) ABSTRACT

For improving the braking performance of a vehicle, the method is designed for brake systems that, for the wheel brakes of the front and real axle, each have a separate brake circuit each having a return pump, a plurality of the return pumps being driven by a common motor. In order to reduce the wheel standstill time of at least one wheel during an ABS control, it is provided at least partially to open a valve situated between the master brake cylinder and the inlet side of the return pump of the rear-axle brake circuit, so that the differential pressure present at the return pump of the rear-axle brake circuit becomes reduced.

### BACKGROUND INFORMATION

Vehicles having ABS regulation usually include rotational speed sensors by which the vehicle speed is measured and the wheel slip at the individual wheels is monitored. As soon as an increased wheel slip occurs at one of the wheels, the braking pressure prevailing at the wheel brake is reduced by closing the appertaining inlet valve and opening the outlet valve. The brake fluid then flows out of the wheel brake via the outlet valve into a storage chamber, and is conveyed back from there, using a return pump, in the direction of the master brake cylinder. The return pump, in this context, has to convey the brake fluid from a low pressure in the storage chamber against a high pressure of the main brake cylinder. This will be explained again below, with reference to FIG. 1.

FIG. 1 shows a braking system known from the related art, having a rear-axle brake circuit I for wheel brakes 10a, 10b of the rear axle and a front-axle brake circuit II for wheel brakes 10c, 10d of the front axle (so-called black and white split of the brake circuit). The braking system includes a brake pedal 1, a brake booster 2 and a master brake cylinder 3 having a brake fluid reservoir situated on it. Rear-axle brake circuit I includes a high-pressure control valve 4a, a switch-over valve 5a, a return pump 6a, a temporary storage 8a and a relief valve 11a. On wheel brakes 10a and 10b, inlet valves 7a and 7b are provided, respectively, and so are outlet valves 9a and 9b. Front-axle brake circuit II is of the same construction, and includes a separate return pump 6b. The two return pumps 6a, 6b are driven by a common electric motor 12, in this instance.

As soon as the wheel slip at one of the wheels exceeds a specified threshold value, the associated inlet valve (e.g. 7c or 7d) is closed and the associated outlet valve (e.g. 9c or 9d) is opened. The hydraulic fluid then flows out of wheel brakes 10c, 10d into a temporary storage 8b. In addition, pump motor 12 is actuated, so that return pumps 6a, 6b convey the hydraulic fluid from temporary storage 8a or 8b back in the direction of master brake cylinder 3.

If the driver operates brake pedal 1 very forcefully, return pumps 6a, 6b have to work against a very high driver admission pressure. This may lead to the situation that the pump runs only very slowly and does not achieve the desired rotational speed nominal value at all. Because of that, pumps 6a, 6b convey less hydraulic fluid/time than would actually be desired, so that the pressure reduction at wheel brakes 10a-10d takes place more slowly than was assumed. This, in turn, leads to prolonged wheel standstill times, i.e. time phases in which the wheels are blocked. During this time, the vehicle cannot be steered, which endangers driving safety.

### SUMMARY OF THE INVENTION

It is therefore an object of the present invention to abbreviate the wheel standstill times and thereby to improve the braking performance.

This objective is attained according to the present invention.

According to the present invention, it is provided, in a vehicle having black and white split of the brake circuit (that is, the brake circuits are subdivided by axle), to open a valve in the rear-axle brake circuit at least partially, so that the differential pressure present at the return pump of the rear-axle brake circuit goes down. The valve is preferably situated between the master brake cylinder and the intake side of the return pump of the rear-axle brake circuit. Because of the reduction of the differential pressure at the return pump of the rear-axle brake circuit, the electric drive motor of the return pumps is unloaded. The drive torque of the drive motor is thus available to a greater extent for the return pump of the front-axle brake circuit. Because of that, the brake pressure at the front wheels may be reduced at a maximum gradient, whereby the wheel standstill times of the front wheels (i.e. the time period in which the front wheels block) are able to become shorter. Consequently, the vehicle becomes steerable again more rapidly.

According to one preferred specific embodiment of the present invention, the valve of the rear-axle brake circuit is opened completely. In this case, the differential pressure present at the associated return pump is equal to zero bar. The return pump of the rear-axle brake circuit is then idling.

The valve of the rear-axle brake circuit is preferably opened only when an hydraulic brake pressure, such as the brake pressure generated by the driver by operating the brake pedal, exceeds a specified threshold value. Depending on the vehicle type, the threshold value may amount to 70%-90% of a maximum brake pressure, for example. However, at low brake pressures, the valve should not be actuated.

According to one specific embodiment of the present invention, the valve of the rear-axle brake circuit is actuated only in such brake situations in which the wheel slip at at least one rear wheel is less than a specific threshold value. In the case of complete braking, in which all four wheels of the vehicle block, the valve is not to be opened, for example.

Provided the pressure-reducing valve is open, it is preferably closed again, as soon as the wheel slip at the rear wheels exceeds the slip threshold value. This situation may occur, for example, in response to a braking maneuver in which the vehicle travels from a roadway having a high coefficient of friction to a smooth surface. In this case, at first only the front wheels block, and the rear wheels block only a short time thereafter. The pressure-reducing valve is first opened and, after the rear wheels have also reached the smooth surface, it is closed again as a function of the rear wheel slip.

The valve of a rear-axle brake circuit is preferably a so-called high-pressure control valve. This valve is preferably situated between the intake side of the return pump and the master brake cylinder in a brake line.

### BRIEF DESCRIPTION OF THE DRAWINGS

FIG. 1 shows a motor vehicle braking system according to one specific embodiment of the present invention, having a closed high-pressure control valve.

FIG. 2 shows the motor vehicle according to FIG. 1, having an open high-pressure control valve of the rear-axle brake circuit.

FIG. 3 shows a flow chart to represent some method steps of a method for controlling the high-pressure control valve.

### DETAILED DESCRIPTION

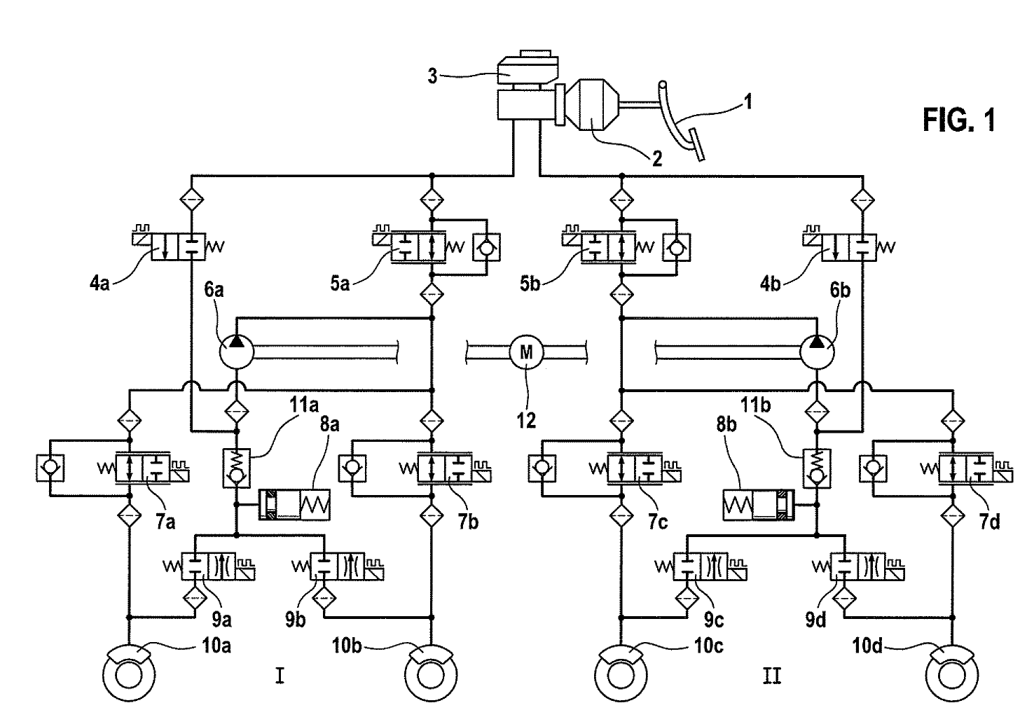

FIG. 1 shows a hydraulic motor vehicle braking system known from the related art, having a rear-axle brake circuit I for wheel brakes 10a, 10b of the rear-axle, and a front-axle brake circuit II for wheel brakes 10c, 10d of the front axle. The braking system includes a brake pedal 1 and a brake booster 2 having a master brake cylinder 3 attached to it, on which a brake fluid container is situated. When brake pedal 1 is operated, a corresponding brake pressure is generated in the main brake lines connected to master brake cylinder 3, which acts on wheel brakes 10a-10d via a switch-over valve 5a, 5b and inlet valves 7a-7d. In this state, switch-over valves 5a, 5b are open (normally open). High-pressure control valves 4a, 4b, that are situated parallel to switch-over valves 5a, 5b and pumps 6a and 6b, are closed in this state (normally closed).

In an ABS control, the brake pressure, acting on wheel brakes 10a-10d, is modulated using inlet valves 7a-7d and outlet valves 9a-9d. The hydraulic fluid flowing away from wheel brakes 10a-10d is stored in a temporary storage 8a and 8b, respectively. A return pump 6a and 6b finally conveys the hydraulic fluid coming from wheel brakes 10a-10d back in the direction of master brake cylinder 3. The two return pumps 6a, 6b are operated by a common electric motor 12, in this instance.

In a braking maneuver in which the driver selects a high brake pressure on brake pedal 1, and an ABS control is triggered, return pumps 6a, 6b have to run up against a relatively high admission pressure. Since electric motor 12 is usually dimensioned to be as small as possible, it may happen that return pumps 6a, 6b run at reduced rotational speed. Because of that, only little hydraulic fluid is able to be conveyed away from wheel brakes 10a-10d. The brake pressure prevailing at wheel brakes 10a-10d is thereby built up only quite slowly, which results in relatively long wheel standstill times.

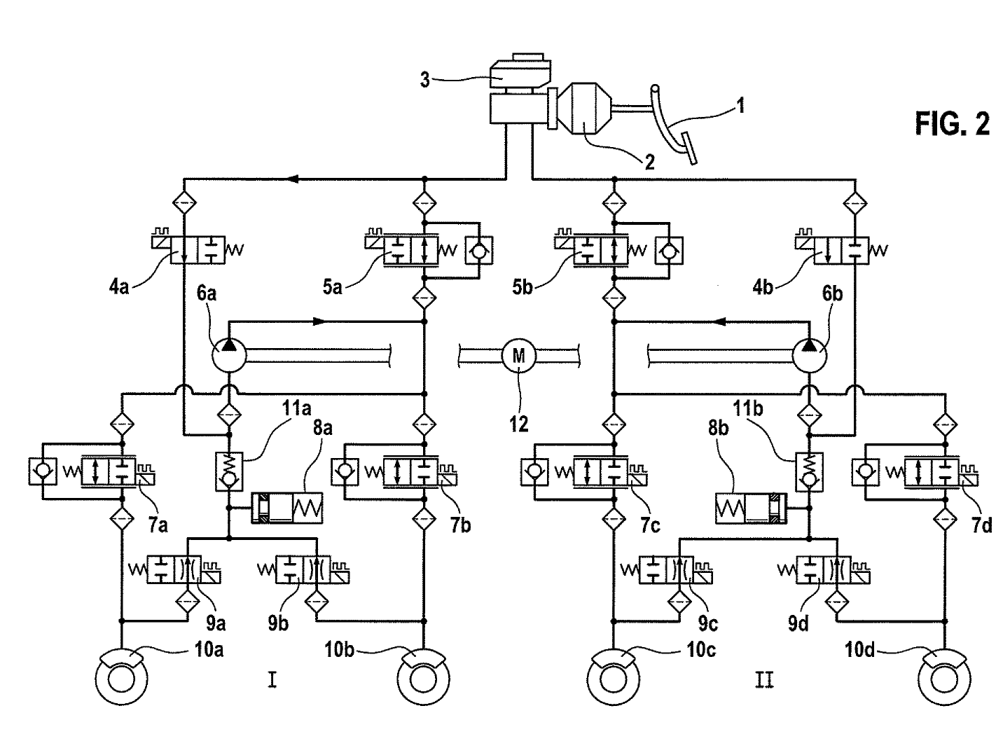

In order to speed up the pressure reduction at wheel brakes 10c, 10d of the front wheels, high-pressure control valve 4a of rear-axle brake circuit I is opened if certain conditions are satisfied. FIG. 2 shows the hydraulic brake system having an opened high-pressure control valve 4a. In the opened state, the driver admission pressure is also present at the input of return pump 6a, so that the differential pressure falling off at return pump 6a is equal to 0 bar. Return pump 6a is thus idling, and does not put a load on drive motor 12 any more. The drive torque of electric motor 12 is thus totally available for driving return pump 6b of front-axle brake circuit

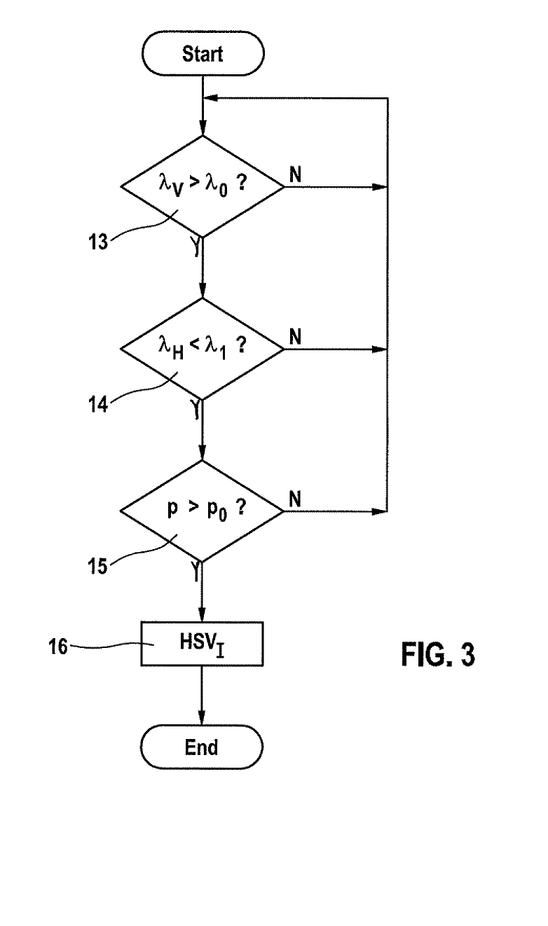

High-pressure control valve 4a is preferably opened only under certain boundary conditions, as shown in an exemplary manner in the flow chart shown in FIG. 3. According to FIG. 3, in a step 13 it is first checked whether the wheel slip of one of front wheels λ_{V} is greater than a specified threshold value λ₀. If yes, it is additionally checked in step 14 whether wheel slip λ_{H} of one of the rear wheels is less than a specified threshold value λ₁. Threshold values λ₀ and λ₁ may be the same or different. If yes, it is checked in step 15 whether the driver admission pressure is greater than a specified threshold value. If all three conditions are satisfied, high-pressure control valve 4a is opened in step 16, and thus return pump 6a is unloaded. If, on the one hand, one of the queries of steps 13 to 15 is negative, the method branches back to step 13 and is processed again regularly.

What is claimed is:

1. A method for improving a braking performance of a vehicle having a hydraulic vehicle braking system which has a front-axle and a rear-axle brake circuit, each having a return pump, respectively, the return pumps being driven by a common motor, the method comprising:
during a braking maneuver, in which, at at least one front wheel, an excessive brake slip occurs, actuating a valve situated between a master brake cylinder and an inlet side of the return pump of the rear-axle brake circuit in such a way that a differential pressure present at the return pump of the rear-axle brake circuit becomes reduced.

2. The method according to claim 1, wherein the valve of the rear-axle brake circuit is opened partially or fully.

3. The method according to claim 1, wherein the valve of the rear-axle brake circuit is opened only when the brake pressure prevailing in a brake circuit exceeds a specified threshold value.

4. The method according to claim 1, wherein the valve of the rear-axle brake circuit is opened only when a wheel slip at at least one rear wheel is less than a specified threshold value.

5. The method according to claim 1, wherein the valve of the rear-axle brake circuit is closed as soon as a wheel slip at at least one front wheel is less than a specified threshold value.

6. A control unit for improving a braking performance of a vehicle having a hydraulic vehicle braking system which has a front-axle and a rear-axle brake circuit, each having a return pump, respectively, the return pumps being driven by a common motor, the control unit comprising:
means for actuating, during a braking maneuver, in which, at at least one front wheel, an excessive brake slip occurs, a valve situated between a master brake cylinder and an inlet side of the return pump of the rear-axle brake circuit in such a way that a differential pressure present at the return pump of the rear-axle brake circuit becomes reduced.
